(19) United States
(12) Patent Application Publication
(10) Pub. No.: US 2023/0311907 A1
(43) Pub. Date: Oct. 5, 2023

(54) DIAGNOSIS APPARATUS, EQUIPMENT, COMPUTER-READABLE STORAGE MEDIUM, AND CONTROL METHOD OF DIAGNOSIS APPARATUS

(71) Applicant: HONDA MOTOR CO.,LTD., Tokyo (JP)

(72) Inventors: Tsutomu KAMIYAMAGUCHI, Saitama (JP); Yasuhito TAKEI, Saitama (JP)

(21) Appl. No.: 18/170,540

(22) Filed: Feb. 17, 2023

(30) Foreign Application Priority Data
Mar. 31, 2022 (JP) 2022-060064

(51) Int. Cl. B60W 50/02; B60W 50/04; B60W 40/13

(52) U.S. Cl. CPC B60W 50/0205; B60W 50/045; B60W 40/13

(57) ABSTRACT

A diagnosis apparatus that is mounted on equipment and diagnoses a state of the equipment includes a timing decision section configured to decide timing at which the diagnosis apparatus diagnoses the state of the equipment. The timing decision section is configured to decide the timing such that a length of a time interval for a diagnosis during a first time period is equal to or less than a first reference value, and a length of a time interval for a diagnosis during a second time period is greater than the first reference value. The first time period and the second time period do not temporally overlap.

The contents of the following Japanese application are incorporated herein by reference.

No. 2022-060064 filed in JP on Mar. 31, 2022.

### BACKGROUND

### 1. Technical Field

The present invention relates to a diagnosis apparatus, equipment, a computer-readable storage medium, and a control method of the diagnosis apparatus.

### 2. Related Art

Patent Document 1 discloses that usage history data of a main battery of an electrically driven vehicle is periodically accumulated in a storage section and a deterioration diagnosis is executed on a fixed cycle. Patent Document 1 also discloses that the deterioration diagnosis is not performed for approximately one year from a start of use of the main battery.

### PRIOR ART DOCUMENT

### Patent Document

Patent Document 1: Japanese Patent Application Publication No. 2018-029430.

### BRIEF DESCRIPTION OF THE DRAWINGS

FIG. 1 schematically shows an example of a system configuration of a mobile object 100.

FIG. 2 schematically shows an example of a system configuration of a driving unit 140.

FIG. 3 schematically shows an example of a system configuration of a control unit 160.

FIG. 4 schematically shows an example of information processing in a diagnosis timing decision section 344.

FIG. 5 schematically shows another example of the information processing in the diagnosis timing decision section 344.

FIG. 6 schematically shows another example of the information processing in the diagnosis timing decision section 344.

FIG. 7 schematically shows another example of the information processing in the diagnosis timing decision section 344.

FIG. 8 schematically shows an example of information processing in a start determination section 346.

FIG. 9 schematically shows an example of information processing in a diagnosis processing execution section 348.

FIG. 10 schematically shows an example of an internal configuration of a vehicle 1000.

FIG. 11 schematically shows an example of an internal configuration of a computer 3000.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solution of the invention.

(Overview of a Mobile Object 100)

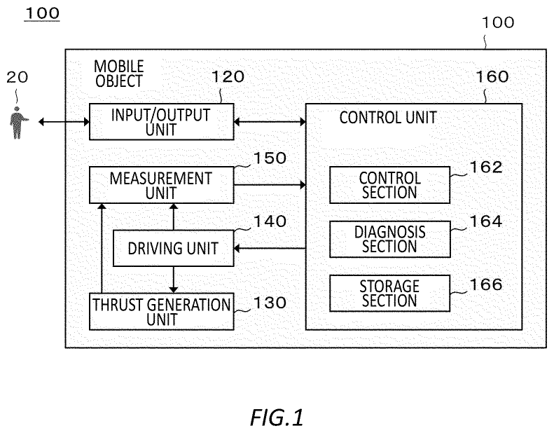

FIG. 1 schematically shows an example of a system configuration of the mobile object 100. In this embodiment, the mobile object 100 will be described in detail by taking as an example a case where the mobile object 100 moves according to an instruction of a user 20. The user 20 may be a passenger of the mobile object 100 or may be an operation manager who manages operation of the mobile object 100.

In this embodiment, the mobile object 100 includes an input/output unit 120, a thrust generation unit 130, a driving unit 140, a measurement unit 150, and a control unit 160, for example. In this embodiment, the control unit 160 has a control section 162, a diagnosis section 164, and a storage section 166.

In this embodiment, the input/output unit 120, the thrust generation unit 130, the driving unit 140, the measurement unit 150, and the control unit 160 are mounted on the mobile object 100, for example. In this embodiment, the input/output unit 120, the driving unit 140, the measurement unit 150, and the control unit 160 are configured to be able to send and receive information to and from each other, for example.

The mobile object 100 moves with a person or an object mounted thereon, for example. The mobile object 100 may move under the control of the user 20 or may autonomously move.

Examples of the mobile object 100 include a vehicle, a flight vehicle, a vessel, and the like. Examples of the vehicle include an automobile, a two-wheeled motor vehicle, a bicycle, a stand-up riding vehicle having a power unit, a work machine, a train, and the like. Examples of the automobile include an electric automobile, a fuel cell vehicle (FCV), a hybrid car, a small commuter, an electrically driven cart, and the like. Examples of the two-wheeled motor vehicle include a motorcycle, a tricycle, and the like. The bicycle may be a motorized bicycle. The motorized bicycle may be an electrically driven bicycle or may be an electrically assisted bicycle. Examples of the work machine include a forklift, a cultivator, a lawn trimmer, and the like. Examples of the flight vehicle include an airplane, an air ship or a balloon, a hot-air balloon, a helicopter, a drone, and the like. Examples of the vessel include a ship, a hovercraft, a water bike, a submarine, a submersible craft, an underwater scooter, and the like.

In this embodiment, the input/output unit 120 receives input of operation or the instruction from the user 20, for example. The input/output unit 120 may acquire information indicating a type of operation instructed by the user 20 to the mobile object 100 and an operation amount. The input/output unit 120 presents a variety of information, for example. The input/output unit 120 may output a variety of information related to a state of the mobile object 100.

The input/output unit 120 includes a variety of input apparatuses and/or a variety of output apparatuses, for example. Examples of the input apparatus include a handle, an accelerator, a brake, a shift lever, a direction indicator, and the like. Other examples of the input apparatus include a keyboard, a pointing device, a touch panel, a camera, a microphone, a speech input system, a gesture input system, and the like. Examples of the output apparatus include a display apparatus, a speaker, and the like. Examples of the display apparatus include a display, a projector, and the like.

In this embodiment, the thrust generation unit 130 generates thrust of the mobile object 100, for example. The thrust generation unit 130 may generate the thrust of the mobile object 100 by utilizing driving force outputted by the driving unit 140. Examples of the thrust generation unit 130 include a wheel, a propeller, and the like.

In this embodiment, the driving unit 140 outputs the driving force for moving the mobile object 100, for example. The driving unit 140 may output braking force for braking the mobile object 100. The driving unit 140 operates based on an instruction from the control unit 160, for example. The driving unit 140 will be described later in detail.

In this embodiment, the measurement unit 150 measures a variety of physical amounts indicating the state of the mobile object 100. The measurement unit 150 may measure a variety of physical amounts indicating a state of the driving unit 140. The measurement unit 150 may output, to the control unit 160, information indicating a measurement result.

The measurement unit 150 may include a variety of sensors. Examples of the above sensor include a vibration sensor, an acoustic emission (AE) sensor, a current sensor, a voltage sensor, a rotation sensor (which may be referred to as resolver), a temperature sensor, a pressure sensor, and the like.

The vibration sensor detects a vibration generated by failure or deterioration of a component (which is a bearing, a gear, a shaft, or the like, for example), for example. The AE sensor detects an elastic wave generated by the failure or the deterioration of the component, for example. The current sensor and/or the voltage sensor detect a change in a waveform generated by the failure or the deterioration of the component. The rotation sensor detects a change in a waveform generated by failure or deterioration of a motor. The temperature sensor measures oil temperature, water temperature, air temperature, surface temperature of the component, internal temperature of the component, or the like, for example. The temperature sensor detects a change in temperature generated by the failure or the deterioration of the component. This allows the failure of the component or a sign of the failure to be detected.

In this embodiment, the control unit 160 controls the mobile object 100, for example. In one embodiment, the control unit 160 manages a state of each unit of the mobile object 100. For example, the control unit 160 acquires a measurement result indicating the state of each unit of the mobile object 100 from the measurement unit 150. The control unit 160 may diagnose the state of each unit of the mobile object 100 (which may be simply referred to as diagnose each unit). In another embodiment, the control unit 160 may control operation of each unit of the mobile object 100. For example, the control unit 160 controls operation of the driving unit 140.

In this embodiment, the control section 162 controls the operation of each unit of the mobile object 100, for example. The control section 162 may acquire the measurement result indicating the state of each unit of the mobile object 100 from the measurement unit 150. The control section 162 may control the operation of each unit of the mobile object 100 based on the above measurement result. The control section 162 controls the operation of the driving unit 140, for example. The control section 162 may control the driving unit 140, to control magnitude of the driving force for moving the mobile object 100. The control section 162 will be described later in detail.

In this embodiment, the diagnosis section 164 diagnoses the state of the mobile object 100, for example. The diagnosis section 164 may diagnose states of at least some components of a plurality of components (which may be referred to as constituent components) constituting the mobile object 100. The diagnosis section 164 diagnoses the state of the driving unit 140, for example. The diagnosis section 164 may diagnose states of at least some components of a plurality of components (which may be referred to as constituent components) constituting the driving unit 140. This allows the diagnosis section 164 to detect the failure of the component or the sign of the failure described above, for example. The diagnosis section 164 will be described later in detail.

In this embodiment, the storage section 166 memorizes (which may be referred to as stores) a variety of information. In one embodiment, the storage section 166 stores a variety of information used for information processing in the mobile object 100. In another embodiment, the storage section 166 stores a variety of information generated through the information processing in the mobile object 100. The storage section 166 will be described later in detail.

The user 20 may be an example of a utilizer. The mobile object 100 may be an example of equipment. The thrust generation unit 130 may be an example of a thrust generation section. The driving unit 140 may be an example of a driving apparatus or a driving section. The driving unit 140 may be an example of reverse thrust equipment or braking equipment. The control unit 160 may be an example of a control apparatus, a diagnosis apparatus, or a diagnosis section. The control section 162 may be an example of the control apparatus, a required driving force decision section, a diagnosis driving force decision section, or a driving control section. The diagnosis section 164 may be an example of the diagnosis apparatus or the diagnosis section. The storage section 166 may be an example of a storage apparatus.

(Overview of the Driving Unit 140)

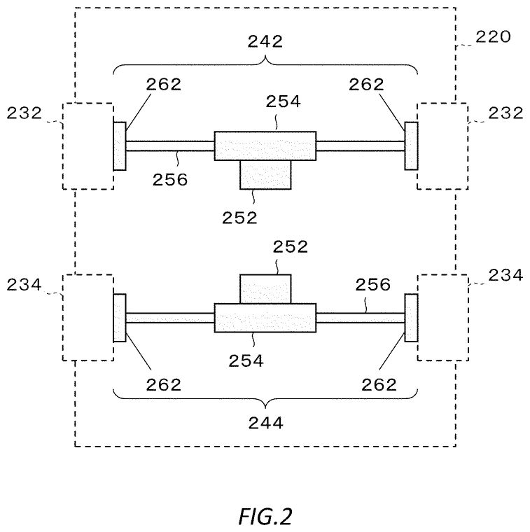

FIG. 2 schematically shows an example of a system configuration of the driving unit 140. In FIG. 2, the system configuration of the driving unit 140 will be described in detail by taking as an example a case where the mobile object 100 is a vehicle. In FIG. 2, for ease of comprehension of the driving unit 140, the system configuration of the driving unit 140 will be described in detail by taking as an example a case where the mobile object 100 includes a vehicle body 220, a pair of front wheels 232, a pair of rear wheels 234, and the driving unit 140.

In this embodiment, the driving unit 140 includes a front wheel driving unit 242 and a rear wheel driving unit 244. In this embodiment, each of the front wheel driving unit 242 and the rear wheel driving unit 244 has a motor 252, a gearbox 254, a shaft 256, and a brake 262.

In this embodiment, one of the front wheel driving unit 242 and the rear wheel driving unit 244 generates at least a part of the driving force (which may be referred to as first driving force) for moving the mobile object 100. In this embodiment, the other of the front wheel driving unit 242 and the rear wheel driving unit 244 adjusts magnitude of the driving force to be outputted by the driving unit 140. For example, the other of the front wheel driving unit 242 and the rear wheel driving unit 244 adjusts the magnitude of the driving force to be outputted by the driving unit 140, by (i) generating a remaining part (which may be referred to as second driving force) of the driving force for moving the mobile object 100 or (ii) generating the braking force for braking the mobile object 100.

In one embodiment, the other of the front wheel driving unit 242 and the rear wheel driving unit 244 generates the braking force by actuating the motor 252 or the gearbox 254 such that the driving force to be outputted by the motor 252 cancels the first driving force to be outputted by one of the front wheel driving unit 242 and the rear wheel driving unit 244. In another embodiment, the other of the front wheel driving unit 242 and the rear wheel driving unit 244 generates the braking force by actuating the brake 262.

In this embodiment, the motor 252 generates power. In this embodiment, the gearbox 254 transmits the power generated by the motor 252 to a front wheel 232 or a rear wheel 234. The gearbox 254 is composed of one or more components. The gearbox 254 includes a rotary component such as a bearing or a gear, for example. In this embodiment, the shaft 256 transmits the power generated by the motor 252 to the front wheel 232 or the rear wheel 234.

The pair of front wheels 232 may be an example of a thrust generation section. The pair of rear wheels 234 may be an example of the thrust generation section. One of the front wheel driving unit 242 and the rear wheel driving unit 244 may be an example of a generation apparatus or a generation section. The other of the front wheel driving unit 242 and the rear wheel driving unit 244 may be an example of an adjustment apparatus or an adjustment section. The motor 252 may be an example of an electric motor. The motor 252 included in the other of the front wheel driving unit 242 and the rear wheel driving unit 244 may be an example of reverse thrust equipment. The gearbox 254 included in the other of the front wheel driving unit 242 and the rear wheel driving unit 244 may be an example of the reverse thrust equipment. The brake 262 may be an example of braking equipment.

### Example of Another Embodiment

In this embodiment, the driving unit 140 has been described in detail by taking as an example a case where each of the front wheel driving unit 242 and the rear wheel driving unit 244 has the motor 252, the gearbox 254, the shaft 256, and the brake 262. However, the driving unit 140 is not limited to this embodiment. In another embodiment, one of the front wheel driving unit 242 and the rear wheel driving unit 244 may not have the motor 252.

(Overview of the Control Unit 160)

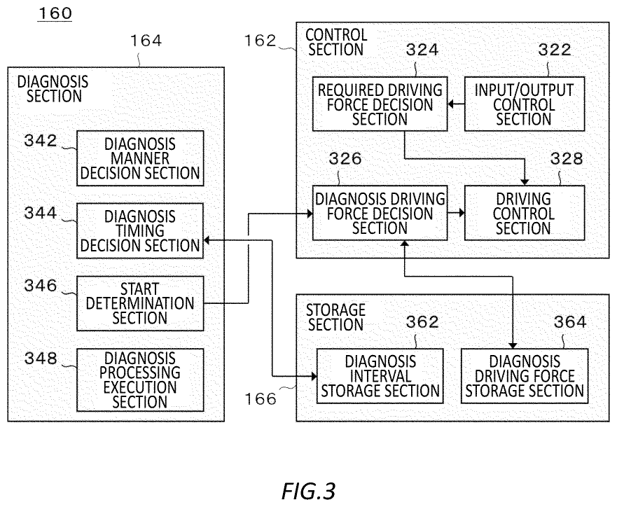

FIG. 3 schematically shows an example of a system configuration of the control unit 160. According to this embodiment, by using FIG. 3, information processing in the control unit 160 will be described in detail by taking as an example a case where the diagnosis section 164 diagnoses a state of the front wheel driving unit 242 or some of components constituting the front wheel driving unit 242.

In this embodiment, the control unit 160 will be described in detail by taking as an example a case where the mobile object 100 moves forward (for example, upward in FIG. 2). In this case, (i) the motor 252, the gearbox 254, and the shaft 256 of the front wheel driving unit 242 generate driving force for moving the mobile object 100 forward, and (ii) the brake 262 of the front wheel driving unit 242 and/or the rear wheel driving unit 244 adjust the magnitude of the driving force to be outputted by the driving unit 140.

According to one embodiment, (i) the motor 252, the gearbox 254, and the shaft 256 of the front wheel driving unit 242 generate the driving force for moving the mobile object 100 forward, and (ii) the brake 262 of the front wheel driving unit 242 and/or the rear wheel driving unit 244 generate braking force that cancels the driving force for moving the mobile object 100 forward. According to another embodiment, (i) the motor 252, the gearbox 254, and the shaft 256 of the front wheel driving unit 242 generate a part of the driving force for moving the mobile object 100 forward, and (ii) the rear wheel driving unit 244 generates a remaining part of the driving force for moving the mobile object 100 forward.

In this embodiment, the control section 162 includes an input/output control section 322, a required driving force decision section 324, a diagnosis driving force decision section 326, and a driving control section 328. In this embodiment, the diagnosis section 164 includes a diagnosis manner decision section 342, a diagnosis timing decision section 344, a start determination section 346, and a diagnosis processing execution section 348. In this embodiment, the storage section 166 includes a diagnosis interval storage section 362 and a diagnosis driving force storage section 364.

In this embodiment, the input/output control section 322 controls input/output between the control unit 160 and each unit of the mobile object 100. The input/output control section 322 acquires information indicating a content of an instruction of the user 20 outputted by the input/output unit 120, for example. The input/output control section 322 acquires information indicating a measurement result outputted by the measurement unit 150, for example. The input/output control section 322 outputs information for controlling operation of the driving unit 140 to the driving unit 140, for example.

In this embodiment, the required driving force decision section 324 decides magnitude of driving force (which may be referred to as required driving force) requested to move the mobile object 100 based on the instruction of the user 20. The required driving force decision section 324 may output, to the driving control section 328, information indicating the magnitude of the required driving force.

The required driving force decision section 324 decides the magnitude of the required driving force based on (i) the content of the instruction of the user 20 and (ii) a performance curve related to the movement of the mobile object 100, for example. The above performance curve is decided based on mass of the mobile object 100, moving resistance of the mobile object 100, or the like, for example. When the mobile object 100 is a vehicle, examples of the above performance curve include a variety of travel performance curves. When the mobile object 100 is a vehicle, the magnitude of the required driving force is decided based on (i) the content of the instruction of the user 20 and (ii) a driving force diagram of the mobile object 100, for example.

For example, consider a case where the content of the instruction of the user 20 is to maintain a movement velocity of the mobile object 100 at 100 km/h. In this case, examples of the instruction of the user 20 include accelerator operation, operation related to cruise control, and the like. The required driving force decision section 324 decides magnitude of force required to maintain the velocity of 100 km/h based on the driving force diagram.

This decides the magnitude of the driving force to be outputted by the driving unit 140. As described above, the output of the driving unit 140 is calculated by summing up force for moving the mobile object 100 forward by the front wheel driving unit 242 and force for moving the mobile object 100 forward or backward by the rear wheel driving unit 244.

In this embodiment, the diagnosis driving force decision section 326 decides magnitude of driving force (which may be referred to as diagnosis driving force) to be generated by the front wheel driving unit 242 during a time period when the diagnosis section 164 executes diagnosis processing. The diagnosis driving force decision section 326 may output, to the driving control section 328, information indicating the magnitude of the diagnosis driving force.

The diagnosis driving force decision section 326 may decide the diagnosis driving force such that magnitude of a load to be applied to a component (which may be referred to as diagnosis target) to be diagnosed in the diagnosis processing by the diagnosis section 164 is greater than that during a time period when the diagnosis processing is not executed. This allows the diagnosis section 164 to precisely diagnose a state of the component.

The diagnosis driving force decision section 326 may decide the magnitude of the diagnosis driving force such that the magnitude of the diagnosis driving force is greater than the magnitude of the required driving force. This allows the diagnosis section 164 to precisely diagnose the state of the component.

As described above, also in a field of the mobile object, it is desired to reduce CO₂ emissions during travel or in a manufacturing process and to improve energy efficiency. As a method for realizing reduced CO₂ emissions in the manufacturing process of a mobile object, it is conceivable to continue to use a mobile object or a component (which may be referred to as mounted component) mounted on the mobile object until an end of its life. This reduces a quantity of mobile objects or mounted components that are newly manufactured, which in turn reduces the CO₂ emissions and energy usage in the manufacturing process of the mobile object.

In order to continue to use the mobile object or the mounted component until the end of its life, it is necessary to grasp a load inputted to the mobile object or the mounted component and to grasp a remaining life of the mobile object or the mounted component. On the other hand, magnitude of a load placed to each unit of the mobile object varies in response to a change in a movement manner, a surrounding environment, or the like. Therefore, it is difficult to accurately diagnose a state of the mobile object and to decide appropriate replacement timing or repair timing.

With respect to these points, the inventors have found that variation in measurement data of a component was greater as a load to be applied to the component was larger. Specifically, the inventors formed an artificial flaw on a part of a rolling contact surface of an outer ring of a bearing, and then changed magnitude of a load to be applied to the bearing, to observe how the bearing vibrates. The magnitude of the load to be applied to the bearing was expressed as magnitude of a load applied to a rotation axis inserted into the bearing in a direction substantially perpendicular to an extending direction of the rotation axis. When fast Fourier transformation was performed on vibration acceleration data, as the load to be applied to the bearing was larger, a value of power spectrum of a frequency corresponding to the above artificial flaw was also greater. Note that applying a load to a particular member may be referred to as inputting a load to the member. Similarly, a load applied to a particular member may be referred to as a load inputted to the member.

According to the above knowledge, even when a degree of abnormality or deterioration of the component is small, the abnormality or deterioration may be detected by executing diagnosis processing under a condition that a large load is applied to the component. Therefore, according to this embodiment, the diagnosis driving force decision section 326 decides the magnitude of the driving force (that is, the diagnosis driving force) to be generated by the front wheel driving unit 242 during the time period when the diagnosis section 164 executes the diagnosis processing such that a load to be applied to the front wheel driving unit 242 as the diagnosis target increases.

When the diagnosis driving force storage section 364 stores the information indicating the magnitude of the diagnosis driving force corresponding to each of one or more constituent components constituting at least a part of the mobile object 100, the diagnosis driving force decision section 326 may decide the diagnosis driving force according to the following procedure. First, the diagnosis driving force decision section 326 decides the diagnosis target which is the component to be diagnosed in the diagnosis processing. Next, the diagnosis driving force decision section 326 refers to the diagnosis driving force storage section 364, to acquire the information indicating the magnitude of the diagnosis driving force corresponding to the diagnosis target decided in the above procedure. This allows the diagnosis driving force decision section 326 to decide the magnitude of the diagnosis driving force.

During a time period when the diagnosis processing is executed, the diagnosis driving force decision section 326 may decide the magnitude of the diagnosis driving force such that the driving force to be outputted by the front wheel driving unit 242 is greater than that at a time point before starting the diagnosis processing and the driving force to be outputted by the rear wheel driving unit 244 is smaller than that at the time point before starting the diagnosis processing. During the time period when the diagnosis processing is executed, the diagnosis driving force decision section 326 may decide the magnitude of the diagnosis driving force such that the driving force to be outputted by the front wheel driving unit 242 is greater than that at the time point before starting the diagnosis processing and the braking force to be generated by the rear wheel driving unit 244 is greater than that at the time point before starting the diagnosis processing. During the time period when the diagnosis processing is executed, the diagnosis driving force decision section 326 may decide the magnitude of the diagnosis driving force such that output of the motor 252 of the front wheel driving unit 242 is greater than that at the time point before starting the diagnosis processing and the braking force of the brake 262 of the front wheel driving unit 242 is greater than that at the time point before starting the diagnosis processing.

In this embodiment, the driving control section 328 controls the operation of the driving unit 140. The driving control section 328 controls the operation of the driving unit 140 based on the magnitude of the required driving force decided by the required driving force decision section 324, for example. The driving control section 328 controls the operation of the driving unit 140 based on the magnitude of the required driving force decided by the required driving force decision section 324 and the magnitude of the diagnosis driving force decided by the diagnosis driving force decision section 326, for example. The driving control section 328 may output the information (which may be referred to as control signal) for controlling the operation of the driving unit 140 to the driving unit 140.

The driving control section 328 may decide magnitude of the driving force to be outputted by the front wheel driving unit 242. The driving control section 328 may control operation of each part of the front wheel driving unit 242. The driving control section 328 may control a load to be applied to each part of the front wheel driving unit 242. The driving control section 328 controls magnitude of the driving force to be outputted by the motor 252 of the front wheel driving unit 242, for example. The driving control section 328 controls magnitude of the braking force to be generated by the brake 262 of the front wheel driving unit 242, for example. This controls magnitude of the load to be applied to each of the motor 252, the gearbox 254, the shaft 256, and the brake 262 that are included in the front wheel driving unit 242.

The driving control section 328 may decide magnitude of the driving force or the braking force to be outputted by the rear wheel driving unit 244. The driving control section 328 may control operation of each part of the rear wheel driving unit 244. The driving control section 328 may control a load to be applied to each part of the rear wheel driving unit 244. The driving control section 328 controls magnitude of the driving force to be outputted by the motor 252 of the rear wheel driving unit 244, for example. The driving control section 328 controls operation of the gearbox 254 of the rear wheel driving unit 244, to control a direction of the driving force to be outputted by the motor 252, for example. The driving control section 328 controls magnitude of the braking force to be generated by the brake 262 of the rear wheel driving unit 244, for example. This controls magnitude of the loads to be applied to the motor 252, the gearbox 254, and the shaft 256 that are included in the rear wheel driving unit 244.

(Control During the Time Period when the Diagnosis Processing is not Executed)

In one embodiment, the driving control section 328 controls the operation of the driving unit 140 based on the magnitude of the required driving force decided by the required driving force decision section 324. For example, when the diagnosis section 164 does not decide to execute the diagnosis processing, the driving control section 328 controls the operation of the driving unit 140 based on the magnitude of the required driving force decided by the required driving force decision section 324.

For example, the driving control section 328 controls the operation of the driving unit 140 such that the magnitude of the driving force to be outputted by the driving unit 140 is the magnitude of the required driving force decided by the required driving force decision section 324. For example, the driving control section 328 decides operation of each of the front wheel driving unit 242 and the rear wheel driving unit 244 such that a total value of the magnitude of the driving force to be outputted by the front wheel driving unit 242 and the magnitude of the driving force to be outputted by the rear wheel driving unit 244 matches the magnitude of the required driving force decided by the required driving force decision section 324. For example, the driving control section 328 decides the operation of each of the front wheel driving unit 242 and the rear wheel driving unit 244 such that a value obtained by subtracting magnitude of the braking force to be generated by the rear wheel driving unit 244 from the magnitude of the driving force to be outputted by the front wheel driving unit 242 matches the magnitude of the required driving force decided by the required driving force decision section 324.

(Control During the Time Period when the Diagnosis Processing is Executed)

In another embodiment, the driving control section 328 controls the operation of the driving unit 140 based on the magnitude of the required driving force decided by the required driving force decision section 324 and the magnitude of the diagnosis driving force decided by the diagnosis driving force decision section 326. For example, when the diagnosis section 164 decides to execute the diagnosis processing, the driving control section 328 controls the operation of the driving unit 140 based on the magnitude of the required driving force decided by the required driving force decision section 324 and the magnitude of the diagnosis driving force decided by the diagnosis driving force decision section 326.

For example, the driving control section 328 controls the operation of the driving unit 140 such that the magnitude of the driving force to be outputted by the driving unit 140 is the magnitude of the required driving force decided by the required driving force decision section 324. For example, the driving control section 328 decides the operation of each of the front wheel driving unit 242 and the rear wheel driving unit 244 such that the total value of the magnitude of the driving force to be outputted by the front wheel driving unit 242 and the magnitude of the driving force to be outputted by the rear wheel driving unit 244 matches the magnitude of the required driving force decided by the required driving force decision section 324. For example, the driving control section 328 decides the operation of each of the front wheel driving unit 242 and the rear wheel driving unit 244 such that the value obtained by subtracting the magnitude of the braking force to be generated by the rear wheel driving unit 244 from the magnitude of the driving force to be outputted by the front wheel driving unit 242 matches the magnitude of the required driving force decided by the required driving force decision section 324.

For example, the driving control section 328 decides the operation of the front wheel driving unit 242 such that the magnitude of the driving force to be outputted by the front wheel driving unit 242 is the magnitude of the diagnosis driving force decided by the diagnosis driving force decision section 326. The driving control section 328 may control the operation of the rear wheel driving unit 244 based on difference between the magnitude of the required driving force decided by the required driving force decision section 324 and the magnitude of the diagnosis driving force decided by the diagnosis driving force decision section 326.

For example, the driving control section 328 decides the magnitude of the driving force or the braking force to be generated by the rear wheel driving unit 244, based on the difference between the magnitude of the required driving force and the magnitude of the diagnosis driving force. If the difference obtained by subtracting the magnitude of the diagnosis driving force from the magnitude of the required driving force is a negative value, the driving control section 328 may control the operation of the rear wheel driving unit 244 such that the rear wheel driving unit 244 generates braking force of magnitude equivalent to an absolute value of the above difference. If the difference obtained by subtracting the magnitude of the diagnosis driving force from the magnitude of the required driving force is a positive value, the driving control section 328 may control the operation of the rear wheel driving unit 244 such that the rear wheel driving unit 244 generates driving force of the magnitude equivalent to the absolute value of the above difference.

In this embodiment, the diagnosis manner decision section 342 decides a manner in which the diagnosis section 164 diagnoses the diagnosis target. Examples of a diagnosis manner include a manner in which the diagnosis target is periodically diagnosed, a manner in which the diagnosis target is diagnosed at random timing, a manner in which the diagnosis target is diagnosed according to a predetermined diagnosis schedule, and the like.

In this embodiment, the diagnosis timing decision section 344 decides timing at which the diagnosis section 164 diagnoses the diagnosis target. The diagnosis timing decision section 344 decides the timing at which the diagnosis section 164 diagnoses the diagnosis target, by deciding a diagnosis frequency or a diagnosis interval (which may be simply referred to as diagnosis interval), for example. The diagnosis frequency indicates the number of times of the diagnosis during a unit time period having a predetermined length. The diagnosis interval indicates a time interval between two temporally consecutive diagnoses.

The diagnosis timing decision section 344 decides diagnosis timing, by deciding the diagnosis interval such that the diagnosis interval differs depending on the timing. The diagnosis timing decision section 344 may decide the diagnosis interval based on an elapsed time period after the mobile object 100 is produced and/or a degree of a load applied to the mobile object 100 or the diagnosis target. The above degree of the load is decided based on a cumulative value of the load applied to the mobile object 100 or the diagnosis target, for example.

The diagnosis timing decision section 344 may decide the diagnosis interval for each diagnosis target or may decide the diagnosis interval for each type of diagnosis target. In one embodiment, the diagnosis timing decision section 344 refers to a database that associates identification information of the diagnosis target and information indicating the diagnosis interval for each diagnosis timing, to decide the diagnosis interval at each timing of each diagnosis target. In another embodiment, the diagnosis timing decision section 344 refers to a database that associates information indicating the type of diagnosis target and the information indicating the diagnosis interval for each diagnosis timing, to decide the diagnosis interval at each timing of each diagnosis target.

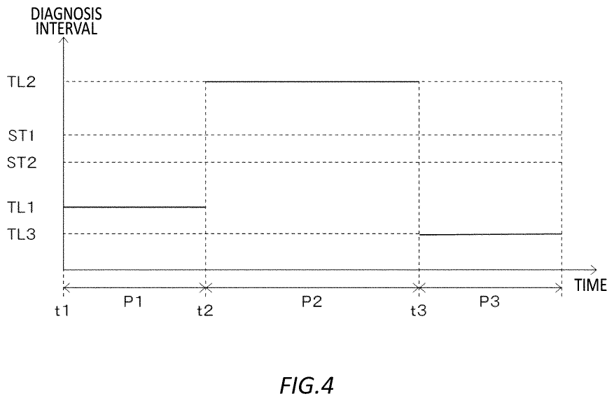

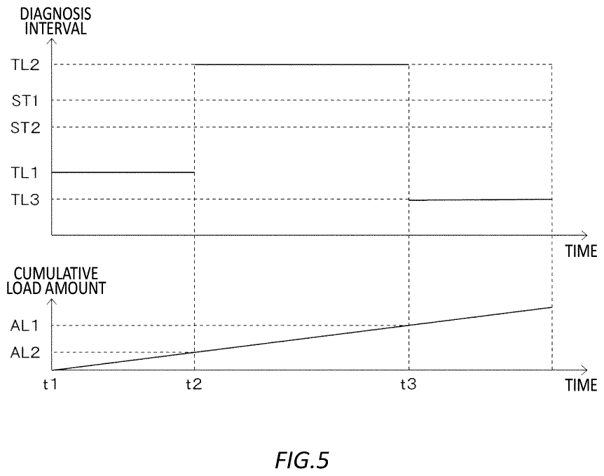

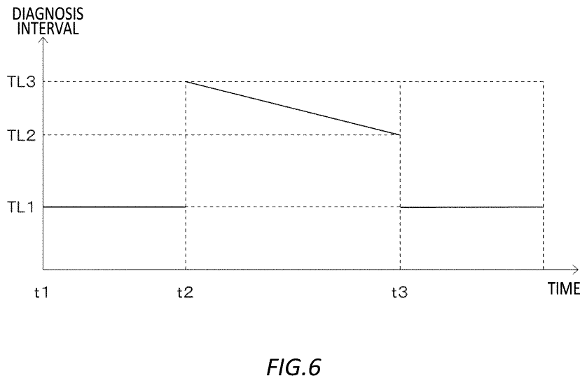

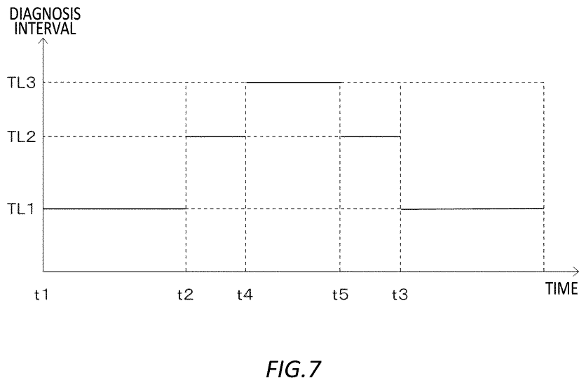

By using an embodiment in which a first time period and a second time period are considered and an embodiment in which the first time period, the second time period, and a third time period are considered, an example of a decision procedure of the diagnosis interval by the diagnosis timing decision section 344 will be described. Note that the decision procedure of the diagnosis interval by the diagnosis timing decision section 344 will be also described in detail in connection to FIG. 4, FIG. 5, FIG. 6, and FIG. 7, for example.

### Embodiment in which the First Time Period and the Second Time Period are Considered

For example, assuming the first time period and the second time period which are two time periods that do not temporally overlap, the diagnosis timing decision section 344 decides the above diagnosis timing such that a length of a time interval for the diagnosis during the first time period is equal to or less than a first reference value and a length of a time interval for the diagnosis during the second time period is greater than the first reference value. When the diagnosis manner decision section 342 decides to operate the diagnosis section 164 in the manner in which the diagnosis target is periodically diagnosed, the diagnosis timing decision section 344 may decide the above diagnosis timing such that a length of a time interval for the periodical diagnosis during the first time period is equal to or less than the first reference value and a length of a time interval for the periodical diagnosis during the second time period is greater than the first reference value.

According to this embodiment, the diagnosis interval during the second time period is longer than the diagnosis interval during the first time period, and the diagnosis frequency during the second time period is smaller than the diagnosis frequency during the first time period. This can reduce the number of times of the diagnosis to be executed during the first time period and the second time period. As a result, power consumed in diagnosing the mobile object 100 is reduced. In addition, for example, deterioration caused by heat generation of a computer mounted on the mobile object 100 is suppressed.

(Diagnosis Interval During the First Time Period)

In one embodiment, when a length of an elapsed time period from a time point (which may be referred to as first time point) where the mobile object 100 was produced or transferred to a utilizer of equipment is smaller than a predetermined value (which may be referred to as first threshold value), the diagnosis timing decision section 344 may decide the above diagnosis timing based on a length of a time interval (which may be referred to as first time interval) during the first time period. In this case, the diagnosis timing decision section 344 decides to execute an (n+1)th diagnosis when the first time interval has elapsed after an nth diagnosis was executed, for example. n may be 0 or an integer of one or more.

The (n+1)th diagnosis may not be executed immediately after the diagnosis timing decision section 344 decides to execute the (n+1)th diagnosis. For example, even when the diagnosis timing decision section 344 decides to execute the (n+1)th diagnosis, the diagnosis of the mobile object 100 may not be able to be executed depending on a utilization situation of the mobile object 100.

The diagnosis timing decision section 344 may decide, as a length of the first time interval, a predetermined value or a value designated by the user. The diagnosis timing decision section 344 may decide the length of the first time interval based on the length of the elapsed time period from the first time point. The diagnosis timing decision section 344 may decide the length of the first time interval such that the length of the first time interval is greater as the length of the elapsed time period from the first time point is greater.

The diagnosis timing decision section 344 may refer to the diagnosis interval storage section 362, to decide the length of the first time interval. For example, when the diagnosis interval storage section 362 stores a condition related to the length of the elapsed time period from the first time point described above and a diagnosis interval for a case where the condition is satisfied in association with each other, the diagnosis timing decision section 344 calculates the length of the elapsed time period from the first time point at a present time, and refers to the diagnosis interval storage section 362, to acquire information indicating the diagnosis interval corresponding to the length of the elapsed time period. For example, when the diagnosis interval storage section 362 stores a condition related to the degree of the load applied to the diagnosis target from the first time point described above and the diagnosis interval for the case where the condition is satisfied in association with each other, the diagnosis timing decision section 344 calculates the above degree of the load at a present time, and refers to the diagnosis interval storage section 362, to acquire information indicating the diagnosis interval corresponding to the degree of the load.

The first time period may be a time period from the first time point to a time point (which may be referred to as second time point) where the length of the elapsed time period from the first time point reaches the first threshold value. The second time period may be a time period after the second time point is exceeded, until a time point (which may be referred to as third time point) where the degree of the load applied to the diagnosis target during the elapsed time period from the first time point reaches a predetermined degree.

(Diagnosis Interval During the Second Time Period)

In another embodiment, when the length of the elapsed time period from the first time point is greater than the first threshold value and the degree of the load applied to the diagnosis target during the elapsed time period from the first time point is smaller than a predetermined first degree, the diagnosis timing decision section 344 may decide timing based on a length of a time interval (which may be referred to as second time interval) during the second time period. According to this embodiment, commencement of the second time period is, for example, a time point where the length of the elapsed time period from the first time point exceeds the first threshold value, and termination of the second time period is, for example, a time point where the degree of the load applied to the diagnosis target during the elapsed time period from the first time point reaches the first degree. Note that the commencement of the second time period may be a time point where the length of the elapsed time period from the first time point reaches the first threshold value, and the termination of the second time period may be a time point where the degree of the load applied to the diagnosis target during the elapsed time period from the first time point exceeds the first degree.

In this case, the diagnosis timing decision section 344 decides to execute the (n+1)th diagnosis when the second time interval has elapsed after the nth diagnosis was executed, for example. As described above, the (n+1)th diagnosis may not be executed immediately after the diagnosis timing decision section 344 decides to execute the (n+1)th diagnosis.

The diagnosis timing decision section 344 may decide, as a length of the second time interval, a predetermined value or a value designated by the user. The diagnosis timing decision section 344 may decide the length of the second time interval based on the degree of the load applied to the diagnosis target during the elapsed time period from the first time point. The diagnosis timing decision section 344 may decide the length of the second time interval such that the length of the second time interval is smaller as the degree of the load applied to the diagnosis target during the elapsed time period from the first time point is larger.

The diagnosis timing decision section 344 may refer to the diagnosis interval storage section 362, to decide the length of the second time interval. For example, when the diagnosis interval storage section 362 stores the condition related to the length of the elapsed time period from the first time point described above and the diagnosis interval for the case where the condition is satisfied in association with each other, the diagnosis timing decision section 344 calculates the length of the elapsed time period from the first time point at a present time, and refers to the diagnosis interval storage section 362, to acquire the information indicating the diagnosis interval corresponding to the length of the elapsed time period. For example, when the diagnosis interval storage section 362 stores the condition related to the degree of the load applied to the diagnosis target from the first time point described above and the diagnosis interval for the case where the condition is satisfied in association with each other, the diagnosis timing decision section 344 calculates the above degree of the load at a present time, and refers to the diagnosis interval storage section 362, to acquire the information indicating the diagnosis interval corresponding to the degree of the load.

### Embodiment in which the First Time Period, the Second Time Period, and the Third Time Period are Considered

For example, assuming the first time period, the second time period, and the third time period which are three time periods that do not temporally overlap, the diagnosis timing decision section 344 decides the above diagnosis timing such that the length of the time interval for the diagnosis during the first time period is equal to or less than the first reference value and the length of the time interval for the diagnosis during the second time period is greater than the first reference value. In addition, the diagnosis timing decision section 344 decides the above diagnosis timing such that a length of a time interval for the diagnosis during the third time period is equal to or less than a second reference value and the length of the time interval for the diagnosis during the second time period is greater than the second reference value. For example, when the diagnosis manner decision section 342 decides to operate the diagnosis section 164 in the manner in which the diagnosis target is periodically diagnosed, the diagnosis timing decision section 344 may decide the diagnosis timing according to the above procedure.

The first reference value and the second reference value may be the same or may be different. The first reference value may be greater than the second reference value or may be smaller than the second reference value. An absolute value of difference between the first reference value and the second reference value may be less than 24 hours. The second time period may start after the first time period ends. The third time period may start after the second time period ends.

According to this embodiment, the diagnosis interval during the second time period is longer than the diagnosis interval during the first time period, and the diagnosis frequency during the second time period is smaller than the diagnosis frequency during the first time period. On the other hand, the diagnosis interval during the third time period is shorter than the diagnosis interval during the second time period, and a diagnosis frequency during the third time period is greater than the diagnosis frequency during the second time period. This improves precision of the diagnosis during the first time period and the third time period. In addition, as described above, this can reduce the number of times of the diagnosis to be executed during the second time period.

For example, during a time period (for example, first time period) until a predetermined time elapses after the mobile object 100 is produced, failure caused by an initial defect of a component is likely to occur. On the other hand, when the above time period has elapsed, the failure caused by the initial defect of the component is less likely to occur. Subsequently, deterioration, wear, or the like of the component progresses beyond a certain level, failure caused by the deterioration, the wear, or the like of the component is likely to occur.

Therefore, decreasing the diagnosis interval during the first time period allows the diagnosis section 164 to detect a sign of the failure caused by the initial defect of the component. In addition, after the first time period has elapsed, increasing the diagnosis interval during the second time period allows the diagnosis section 164 to suppress increase in power consumption associated with the diagnosis, deterioration of the computer, or the like. Further, decreasing the diagnosis interval during the third time period allows the diagnosis section 164 to detect a sign of the failure caused by the deterioration, the wear, or the like of the component.

In this embodiment, the start determination section 346 decides whether to execute the diagnosis processing. As described above, examples of the diagnosis target of the diagnosis processing include the driving unit 140 or a constituent component of the driving unit 140. In addition, in the diagnosis processing, a state of the diagnosis target is diagnosed.

The start determination section 346 decides to execute the diagnosis processing when a state of the mobile object 100 matches a predetermined condition (which may be referred to as diagnosis start condition). The start determination section 346 may decide to execute the diagnosis processing when the diagnosis timing has come and the state of the mobile object 100 matches the diagnosis start condition.

Examples of the state of the mobile object 100 include a movement status of the mobile object 100. Examples of the movement status of the mobile object 100 include a degree of stability of the mobile object 100, a degree of stability of the number of rotations of a rotary component included in the mobile object 100, and the like. Examples of the above rotary component include the driving unit 140, the constituent component of the driving unit 140, and the like.

Examples of the above diagnosis start condition include at least one of a condition that a manner of operation of a mobile object by a utilizer of the mobile object matches a predetermined condition (which may be referred to as operation condition), a condition that a degree of acceleration of the mobile object is smaller than a predetermined degree, or a condition that a degree of turning of the mobile object is smaller than a predetermined degree. If the number of rotations of the rotary component included in the mobile object 100 is relatively stable, these conditions may be met.

Other examples of the above diagnosis start condition include at least one of a condition that an amount of steering by the user 20 is smaller than a predetermined value, a condition that brake operation is not performed, a condition that a brake operation amount is smaller than a predetermined value, a condition that a state of a road surface matches a predetermined condition (which may be referred to as road surface condition), or a condition that a system for automatically stabilizing a behavior of the mobile object 100 is not actuated. If the state of the mobile object 100 is relatively stable, these conditions may be met.

Examples of the road surface condition include a condition that magnitude of friction force acting on a contact surface of a tire and the road surface or magnitude of a friction coefficient of the friction is greater than a predetermined value. Examples of the system for automatically stabilizing the behavior of the mobile object 100 include a safety apparatus such as an anti-lock brake system (ABS), a traction control system (TCS), and a sideslip suppressing apparatus, a system totally controlling these safety apparatuses, or the like.

In this embodiment, the diagnosis processing execution section 348 executes the diagnosis processing, for example. The diagnosis processing execution section 348 may start diagnosing the diagnosis target when start determination section 346 decides to execute the diagnosis processing. Examples of the diagnosis target of the diagnosis processing include the driving unit 140 or the constituent component of the driving unit 140. In addition, in the diagnosis processing, the state of the diagnosis target is diagnosed.

In this embodiment, the diagnosis interval storage section 362 stores a condition related to timing and a diagnosis interval at the timing in association with each other. In one embodiment, the diagnosis interval storage section 362 stores the condition related to the length of the elapsed time period from the first time point described above and the diagnosis interval for the case where the condition is satisfied in association with each other. In another embodiment, the diagnosis interval storage section 362 stores the condition related to the degree of the load applied to the diagnosis target from the first time point described above and the diagnosis interval for the case where the condition is satisfied in association with each other. In yet another embodiment, the diagnosis interval storage section 362 stores a combination of the condition related to the length of the elapsed time period from the first time point described above and the condition related to the degree of the load applied to the diagnosis target from the first time point described above as well as a diagnosis interval for a case where the combination of the conditions are satisfied in association with each other.

In this embodiment, the diagnosis driving force storage section 364 stores the information indicating the magnitude of the diagnosis driving force corresponding to each of the one or more constituent components constituting at least a part of the mobile object 100. In one embodiment, the diagnosis driving force storage section 364 stores information indicating a type of a constituent component and information indicating magnitude of diagnosis driving force suitable for diagnosing the constituent component in association with each other. In another embodiment, the diagnosis driving force storage section 364 stores identification information for identifying each of the one or more constituent components constituting at least a part of the mobile object 100 and information indicating magnitude of diagnosis driving force suitable for diagnosing the constituent components in association with each other.

(Specific Configuration of Each Section of the Control Unit 160)

Each section of the control unit 160 may be realized by hardware, may be realized by software, or may be realized by hardware and software. Each section of the control unit 160 may be, at least partially, realized by a single server or a plurality of servers. Each section of the control unit 160 may be, at least partially, realized on a virtual machine or a cloud system. Each section of the control unit 160 may be, at least partially, realized by a personal computer or a mobile terminal. Examples of the mobile terminal can include a mobile phone, a smartphone, a PDA, a tablet, a notebook computer or a laptop computer, a wearable computer, and the like. Each section of the control unit 160 may store information by utilizing a distributed ledger technology or a distributed network such as a blockchain.

If at least some of constituent elements constituting the control unit 160 are realized by software, the constituent elements realized by the software may be realized by activating, in an information processing apparatus having a general configuration, software or a program stipulating operations related to the constituent elements. The above information processing apparatus with a general configuration may comprise (i) a data processing apparatus having a processor such as a CPU or a GPU, a ROM, a RAM, a communication interface, or the like, (ii) an input apparatus such as a keyboard, a pointing device, a touch panel, a camera, a speech input apparatus, a gesture input apparatus, a variety of sensors, a GPS receiver, and (iii) an output apparatus such as a display apparatus, a speech output apparatus, a vibration apparatus, and (iv) a storage apparatus (including an external storage apparatus) such as a memory, an HDD, or an SSD.

In the above information processing apparatus having a general configuration, the above data processing apparatus or storage apparatus may store the above software or program. By being executed by a processor, the above software or program causes the above information processing apparatus to execute the operations stipulated by the software or the program. The above software or program may be stored in a non-transitory computer-readable recording medium. The above software or program may be a program for causing a computer to function as the control unit 160 or a part thereof. The above software or program may be a program for causing a computer to execute an information processing method in the control unit 160 or a part thereof.

In one embodiment, the above information processing method may be a control method for controlling magnitude of driving force for moving a mobile object. In the above control method, the mobile object may include a driving apparatus that outputs the driving force for moving the mobile object. In the above control method, the driving apparatus may have a generation apparatus that generates first driving force which is at least a part of the driving force, and an adjustment apparatus that adjusts, by generating braking force or second driving force which is a remaining part of the driving force, magnitude of the driving force to be outputted by the driving apparatus.

The above control method has deciding required driving force by deciding magnitude of required driving force which is driving force requested to move the mobile object based on an instruction of a utilizer of the mobile object, for example. The above control method has deciding necessity by deciding whether to execute diagnosis processing for diagnosing a state of the driving apparatus, for example. The above control method has deciding diagnosis driving force by deciding magnitude of diagnosis driving force which is driving force to be generated by the generation apparatus during a time period when the diagnosis processing is executed, for example. The above control method has controlling operation of the driving apparatus, for example.

In the above control method, the controlling includes (a) controlling the operation of the driving apparatus based on the magnitude of the required driving force decided in the deciding required driving force, when it is not decided that the diagnosis processing is executed in the deciding necessity, for example. The controlling includes (b) controlling the operation of the driving apparatus based on the magnitude of the required driving force decided in the deciding required driving force and the magnitude of the diagnosis driving force decided in the deciding diagnosis driving force, when it is decided that the diagnosis processing is executed in the deciding necessity, for example.

In another embodiment, the above information processing method may be a control method of a diagnosis apparatus that is mounted on equipment and diagnoses a state of the equipment. The above control method has deciding timing at which the diagnosis apparatus diagnoses the state of the equipment, for example. In the above control method, the deciding timing includes deciding the timing such that a length of a time interval for a diagnosis during a first time period is equal to or less than a first reference value and a length of a time interval for a diagnosis during a second time period is greater than the first reference value, for example. In the above control method, the first time period and the second time period do not temporally overlap.

The diagnosis section 164 may be an example of a necessity decision section. The diagnosis manner decision section 342 may be an example of a manner decision section. The diagnosis timing decision section 344 may be an example of a timing decision section. The start determination section 346 may be an example of a necessity decision section. The diagnosis processing execution section 348 may be an example of a diagnosis section. The diagnosis driving force storage section 364 may be an example of a storage apparatus. A component as a diagnosis target may be an example of equipment.

### Example of Another Embodiment

In this embodiment, the diagnosis timing decision section 344 has been described in detail by taking as an example a case where commencement of the second time period is a time point where the length of the elapsed time period from the first time point exceeds the first threshold value, and termination of the second time period is a time point where the degree of the load applied to the diagnosis target during the elapsed time period from the first time point reaches the first degree. However, the diagnosis timing decision section 344 is not limited to this embodiment.

In another embodiment, the commencement of the second time period may be a time point where the length of the elapsed time period from the first time point exceeds the first threshold value, and the termination of the second time period may be a time point where the length of the elapsed time period from the first time point reaches a predetermined second threshold value. According to the above embodiment, when the length of the elapsed time period from the first time point is greater than the first threshold value and smaller than the predetermined second threshold value, the diagnosis timing decision section 344 decides diagnosis timing based on a length of a time interval (which may be referred to as second time interval) during the second time period.

In yet another embodiment, when a degree of a load applied to the equipment during the elapsed time period from the first time point is smaller than a predetermined first degree, the diagnosis timing decision section 344 may decide the diagnosis timing based on the length of the second time interval which is the time interval during the second time period. In yet another embodiment, when the degree of the load applied to the equipment during the elapsed time period from the first time point is (a) greater than the first degree or (b) smaller than a predetermined second degree, the diagnosis timing decision section 344 may decide the diagnosis timing based on a length of a first time interval which is the time interval during the first time period. In this case, the second degree may indicate to be smaller than the first degree in terms of the degree of the load.

In this embodiment, the control unit 160 has been described in detail by taking as an example a case where the start determination section 346 is included in the diagnosis section 164. However, the control unit 160 is not limited to this embodiment. In another embodiment, the start determination section 346 may be included in the control section 162. In this case, the control section 162 may be an example of a control apparatus.

In this embodiment, information processing in the control unit 160 has been described in detail by taking as an example a case where the diagnosis section 164 diagnoses a state of the front wheel driving unit 242 or some of components constituting the front wheel driving unit 242. However, the control unit 160 is not limited to this embodiment. In another embodiment, the control unit 160 may diagnose a state of another component constituting the mobile object 100.

FIG. 4 schematically shows an example of information processing in the diagnosis timing decision section 344. In FIG. 4, t1 shows an example of the first time point described above. t2 shows an example of the second time point described above. t3 shows an example of the third time point described above.

As described above, t1 indicates the time point where (i) the mobile object 100 is produced or (ii) the time point where the mobile object 100 is transferred from a producer to the user 20. t2 may be (i) a time point where a length of an elapsed time period from the first time point reaches a first threshold value, or may be (ii) a time point where a degree of a load applied to the mobile object 100 or a diagnosis target during the elapsed time period from the first time point reaches a second degree. t3 may be (i) a time point where the degree of the load applied to the mobile object 100 or the diagnosis target during the elapsed time period from the first time point reaches a first degree, or may be (ii) a time point where the length of the elapsed time period from the first time point reaches a second threshold value.

For example, the above first degree indicates an accumulated load amount which is larger than the above second degree. For example, the above second threshold value is greater than the above first threshold value.

As described above, t2 may be the time point where the length of the elapsed time period from the first time point reaches the first threshold value. This allows the diagnosis section 164 to detect a sign of failure caused by an initial defect of a component. t3 may be the time point where the degree of the load applied to the mobile object 100 or the diagnosis target during the elapsed time period from the first time point reaches the first degree. This allows the diagnosis section 164 to detect a sign of failure caused by deterioration, wear, or the like of the component.

Similarly, a time period P1 shows an example of the first time period described above. A time period P2 shows an example of the second time period described above. A time period P3 shows an example of the third time period described above.

In FIG. 4, a decision method of diagnosis timing in the diagnosis timing decision section 344 will be described in detail by taking as an example a case where commencement of the time period P2 is after an end of the time period P1 and commencement of the time period P3 is after an end of the time period P2. As described above, the diagnosis timing decision section 344 decides (n+1)th diagnosis timing by deciding a time interval until the (n+1)th diagnosis is executed after the nth diagnosis is executed.

As described above, timing at which the diagnosis processing execution section 348 starts diagnosis processing is decided by the start determination section 346. Therefore, an actual diagnosis interval may be longer than TL1 depending on the state of the mobile object 100.

As shown in FIG. 4, according to this embodiment, the diagnosis timing decision section 344 decides the diagnosis timing such that a diagnosis interval is TL1 during the time period P1, for example. The diagnosis timing decision section 344 decides the diagnosis timing such that the diagnosis interval is TL2 during the time period P2, for example. The diagnosis timing decision section 344 decides the diagnosis timing such that the diagnosis interval is TL3 during the time period P3, for example.

As shown in FIG. 4, TL2 is a value greater than ST1, and TL1 is a value smaller than ST1. The diagnosis timing decision section 344 may decide TL1 such that TL1 is smaller than ST1. The diagnosis timing decision section 344 may decide TL2 such that TL2 is greater than ST1.

At least one of TL1 or TL2 may be a predetermined value. At least one of TL1 or TL2 may be decided based on a length of an elapsed time period from t1. At least one of TL1 or TL2 may be decided based on a degree of a load applied to the diagnosis target during the elapsed time period from t1.

As shown in FIG. 4, TL2 is a value greater than ST2, and TL3 is a value smaller than ST2. The diagnosis timing decision section 344 may decide TL2 such that TL2 is greater than ST2. The diagnosis timing decision section 344 may decide TL3 such that TL3 is smaller than ST2.

As described above, at least one of TL2 or TL3 may be a predetermined value. At least one of TL2 or TL3 may be decided based on the length of the elapsed time period from t1. At least one of TL2 or TL3 may be decided based on the degree of the load applied to the diagnosis target during the elapsed time period from t1.

TL1 may be an example of one of a first time interval and a second time interval. TL2 may be an example of the other of the first time interval and the second time interval. TL1 may be an example of the first time interval. TL2 may be an example of the second time interval. TL3 may be an example of a third time interval. ST1 may be an example of a first reference value. ST2 may be an example of a second reference value.

### Example of Another Embodiment

In this embodiment, an example of the information processing in the diagnosis timing decision section 344 has been described by taking as an example a case where ST1 is greater than ST2. Specifically, an example of decision processing of the diagnosis interval has been described. However, the information processing in the diagnosis timing decision section 344 is not limited to this embodiment. In another embodiment, ST1 and ST2 may be equal, or ST1 may be smaller than ST2.

In this embodiment, an example of the information processing in the diagnosis timing decision section 344 has been described by taking as an example a case where TL1 is greater than TL3. Specifically, an example of decision processing of the diagnosis interval has been described. However, the information processing in the diagnosis timing decision section 344 is not limited to this embodiment. In another embodiment, TL1 and TL3 may be equal, or TL1 may be smaller than TL3.

In this embodiment, an example of the information processing in the diagnosis timing decision section 344 has been described by taking as an example a case where a diagnosis interval during the first time period is fixed. Specifically, an example of decision processing of the diagnosis interval has been described. However, the information processing in the diagnosis timing decision section 344 is not limited to this embodiment. In another embodiment, diagnosis intervals may be different at a plurality of time points included in the first time period. The diagnosis interval during the first time period may consecutively change depending on time or may stepwisely change depending on time.

In this embodiment, an example of the information processing in the diagnosis timing decision section 344 has been described by taking as an example a case where a diagnosis interval during the second time period is fixed. Specifically, an example of decision processing of the diagnosis interval has been described. However, the information processing in the diagnosis timing decision section 344 is not limited to this embodiment. In another embodiment, diagnosis intervals may be different at a plurality of time points included in the second time period. The diagnosis interval during the second time period may consecutively change depending on time or may stepwisely change depending on time.

In this embodiment, an example of the information processing in the diagnosis timing decision section 344 has been described by taking as an example a case where a diagnosis interval during the third time period is fixed. Specifically, an example of decision processing of the diagnosis interval has been described. However, the information processing in the diagnosis timing decision section 344 is not limited to this embodiment. In another embodiment, diagnosis intervals may be different at a plurality of time points included in the third time period. The diagnosis interval during the third time period may consecutively change depending on time or may stepwisely change depending on time.

FIG. 5 schematically shows another example of the information processing in the diagnosis timing decision section 344. By using FIG. 5, an embodiment will be described in which both termination of a time period P1 and termination of a time period P2 are decided based on a degree of a load applied to a diagnosis target during an elapsed time period from t1. According to this embodiment, the time period P1 ends and the time period P2 starts at a time point where a cumulative amount of the load applied to the diagnosis target during the elapsed time period from t1 reaches AL2. Similarly, the time period P2 ends and a time period P3 starts at a time point where the cumulative amount of the load applied to the diagnosis target during the elapsed time period from t1 reaches AL1.

AL1 may be an example of a first degree. AL2 may be an example of a second degree.

FIG. 6 schematically shows another example of the information processing in the diagnosis timing decision section 344. According to an embodiment described in connection to FIG. 6, it is different from the embodiment described in connection to FIG. 4, in that a diagnosis interval during a time period P2 is expressed as a function of an elapsed time period from t1 and/or a degree of a load applied to a diagnosis target during the elapsed time period from t1. According to the embodiment described in connection to FIG. 6, it is different from the embodiment described in connection to FIG. 4, in that a diagnosis interval during a time period P1 and a diagnosis interval during a time period P3 are equal. The embodiment described in connection to FIG. 6 may have features similar to those of the embodiment described in connection to FIG. 4, except for the above points of difference.

In this embodiment, the diagnosis timing decision section 344 decides the diagnosis interval during the time period P2 such that (i) a diagnosis interval at commencement t2 of the time period P2 is TL3, (ii) a diagnosis interval at termination t3 of the time period P2 is TL2, and (iii) the diagnosis interval is smaller as the elapsed time period from t1 and/or the degree of the load applied to the diagnosis target during the elapsed time period from t1 is larger. According to this embodiment, the diagnosis interval during the time period P2 is decided by using a function that consecutively changes depending on the elapsed time period from t1 and/or the degree of the load applied to the diagnosis target during the elapsed time period from t1. Note that the above function used to decide the diagnosis interval is not limited to this embodiment.

FIG. 7 schematically shows another example of the information processing in the diagnosis timing decision section 344. According to an embodiment described in connection to FIG. 7, it is different from the embodiment described in connection to FIG. 6, in that a diagnosis interval during a time period P2 is expressed as a function that stepwisely changes depending on an elapsed time period from t1 and/or a degree of a load applied to a diagnosis target during the elapsed time period from t1.

According to this embodiment, the diagnosis timing decision section 344 decides diagnosis timing such that the diagnosis interval is TL2 during a time period from t2 to t4, for example. The diagnosis timing decision section 344 decides the diagnosis timing such that the diagnosis interval is TL3 during a time period from t4 to t5, for example. The diagnosis timing decision section 344 decides the diagnosis timing such that the diagnosis interval is TL2 during a time period from t5 to t3, for example. TL3 may be a value greater than TL2.

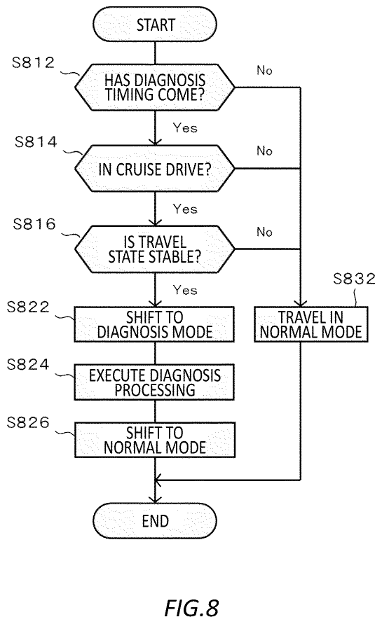

FIG. 8 schematically shows an example of information processing in a start determination section 346. According to this embodiment, first, in Step 812 (Step may be abbreviated as S), it is determined whether diagnosis timing of a diagnosis target has come. For example, the start determination section 346 determines whether the diagnosis timing of the diagnosis target has come, based on a diagnosis interval decided by the diagnosis timing decision section 344 and on time at which a previous diagnosis was executed.

More specifically, the start determination section 346 calculates a length of an elapsed time period from the time at which the previous diagnosis was executed. When the calculated length of the elapsed time period is greater than a value of the diagnosis interval decided by the diagnosis timing decision section 344, the start determination section 346 determines that the diagnosis timing of the diagnosis target has come.

If it is determined that the diagnosis timing of the diagnosis target has not come (in case of No in S812), diagnosis processing is not executed. In this case, in S832, the mobile object 100 travels in a normal mode. For example, the driving control section 328 controls the front wheel driving unit 242 and the rear wheel driving unit 244 such that a sum of an absolute value of output to be generated by the rear wheel driving unit 242 and an absolute value of output to be generated by the front wheel driving unit 244 is output of the driving unit 140. This allows the driving control section 328 to control operation of the driving unit 140 such that magnitude of driving force to be outputted by the driving unit 140 matches magnitude of required driving force.

On the other hand, if it is determined that the diagnosis timing of the diagnosis target has come (in case of Yes in S812), in S814, it is determines whether a degree of variation in a travel velocity of the mobile object 100 is smaller than a predetermined degree. A travel state in which the degree of the variation in the travel velocity of the mobile object 100 is smaller than the predetermined degree may be referred to as cruise travel, cruise drive, or the like. In addition, controlling the mobile object 100 such that the degree of the variation in the travel velocity of the mobile object 100 is smaller than the predetermined degree may be referred to as cruise control.

The start determination section 346 determines whether the mobile object 100 is in the cruise drive, by determining at least one of (i) whether opening of an accelerator pedal is greater than a predetermined value, (ii) whether an amount of variation in the opening of the accelerator pedal during a predetermined time period is smaller than a predetermined value, (iii) whether actual acceleration of the mobile object 100 is smaller than a predetermined value, or (iv) whether turning acceleration of the mobile object 100 is smaller than a predetermined value, for example. For example, when (i) the opening of the accelerator pedal is greater than the predetermined value, (ii) the amount of the variation in the opening of the accelerator pedal during the predetermined time period is smaller than the predetermined value, (iii) the actual acceleration of the mobile object 100 is smaller than the predetermined value, and (iv) the turning acceleration of the mobile object 100 is smaller than the predetermined value, the start determination section 346 determines that the mobile object 100 is in the cruise drive.

If it is determined that the mobile object 100 is not in the cruise drive (in case of No in S814), the diagnosis processing is not executed. In this case, in S832, the mobile object 100 travels in the normal mode.

On the other hand, if it is determined that the mobile object 100 is in the cruise drive (in case of Yes in S814), in S816, it is determined whether the travel state of the mobile object 100 is stable. The diagnosis processing may be performed while the mobile object 100 is travelling or may be performed while the mobile object 100 is stopped. For example, when the diagnosis target is the driving unit 140 or a constituent component of the driving unit 140, the diagnosis processing is executed while the mobile object 100 is travelling.

The start determination section 346 determines whether the travel state of the mobile object 100 is stable, by determining at least one of (i) whether a handle operation amount is smaller than a predetermined value, (ii) whether brake operation is performed, or whether a brake operation amount is smaller than a predetermined value, (iii) whether a state of a road surface matches the road surface condition described above, or (iv) whether a system for automatically stabilizing a behavior of the mobile object 100 is actuated, for example. For example, when (i) the handle operation amount is smaller than the predetermined value, (ii) the brake operation is not performed, or the brake operation amount is smaller than the predetermined value, (iii) magnitude of friction force acting on a contact surface of a tire and the road surface or magnitude of a friction coefficient of the friction is greater than a predetermined value, and (iv) the system for automatically stabilizing the behavior of the mobile object 100 is not actuated, the start determination section 346 determines that the travel state of the mobile object 100 is stable.

If it is determined that the travel state of the mobile object 100 is not stable (in case of No in S816), the diagnosis processing is not executed. In this case, in S832, the mobile object 100 travels in the normal mode.

On the other hand, if it is determined that the travel state of the mobile object 100 is stable (in case of Yes in S816), in S822, an operation mode of the mobile object 100 shifts from the normal mode to a diagnosis mode. For example, the driving control section 328 adjusts output distribution of the front wheel driving unit 242 and the rear wheel driving unit 244. As a result, the operation mode of the mobile object 100 shifts from the normal mode to the diagnosis mode, and the mobile object 100 travels in the diagnosis mode.

In one embodiment, the driving control section 328 controls the front wheel driving unit 242 such that the absolute value of the output to be generated by the front wheel driving unit 242 is the diagnosis driving force. The driving control section 328 controls the front wheel driving unit 242 and the rear wheel driving unit 244 such that a value obtained by subtracting the absolute value of the output or the braking force to be generated by the rear wheel driving unit 244 from the absolute value of the output to be generated by the front wheel driving unit 242 is the required driving force. This allows the driving control section 328 to control the operation of the driving unit 140 such that the magnitude of the driving force to be outputted by the driving unit 140 matches the magnitude of the required driving force.

For example, when the required driving force for causing the mobile object 100 to perform the cruise drive at a particular velocity is 500 N, in the normal mode, the driving control section 328 controls operation of the front wheel driving unit 242 and the rear wheel driving unit 244 such that the brake 262 of the front wheel driving unit 242 is turned off, the front wheel driving unit 242 outputs driving force of 500 N, and the driving force or the braking force of the rear wheel driving unit 244 is about ON. On the other hand, in the diagnosis mode, the driving control section 328 controls the operation of the front wheel driving unit 242 and the rear wheel driving unit 244 such that the brake 262 of the front wheel driving unit 242 is turned off, the front wheel driving unit 242 outputs driving force of 700 N, and the rear wheel driving unit 244 outputs braking force of 200 N. The motor 252 of the rear wheel driving unit 244 may generate the braking force of the rear wheel driving unit 244, the brake 262 of the rear wheel driving unit 244 may generate the braking force of the rear wheel driving unit 244, or the motor 252 and the brake 262 of the rear wheel driving unit 244 may generate the braking force of the rear wheel driving unit 244.

In another embodiment, the driving control section 328 controls the front wheel driving unit 242 such that an absolute value of output to be generated by the motor 252 of the front wheel driving unit 242 is the diagnosis driving force. The driving control section 328 controls the front wheel driving unit 242 and the rear wheel driving unit 244 such that a value obtained by subtracting, from (i) the absolute value of the output to be generated by the motor 252 of the front wheel driving unit 242, (ii) a sum of an absolute value of braking force to be generated by the brake 262 of the front wheel driving unit 242 and the absolute value of the output or the braking force to be generated by the rear wheel driving unit 244 is the required driving force. This allows the driving control section 328 to control the operation of the driving unit 140 such that the magnitude of the driving force to be outputted by the driving unit 140 matches the magnitude of the required driving force.

For example, when the required driving force for causing the mobile object 100 to perform the cruise drive at the particular velocity is 500 N, in the diagnosis mode, the driving control section 328 controls the operation of the front wheel driving unit 242 such that the motor 252 of the front wheel driving unit 242 generates driving force of 750 N and the brake 262 of the front wheel driving unit 242 generates braking force of 50 N. In addition, the operation of the rear wheel driving unit 244 is controlled such that the rear wheel driving unit 244 outputs braking force of 200 N. The motor 252 of the rear wheel driving unit 244 may generate the braking force of the rear wheel driving unit 244, the brake 262 of the rear wheel driving unit 244 may generate the braking force of the rear wheel driving unit 244, or the motor 252 and the brake 262 of the rear wheel driving unit 244 may generate the braking force of the rear wheel driving unit 244.

Next, in S824, the diagnosis processing of the diagnosis target is executed. For example, the diagnosis processing execution section 348 collects data from the measurement unit 150 and analyzes the data, thereby detecting a sign of failure of the diagnosis target and determining a degree of deterioration of the diagnosis target. The diagnosis processing will be described later in detail.

When the diagnosis processing ends in S824, in S826, the operation mode of the mobile object 100 shifts from the diagnosis mode to the normal mode. For example, the driving control section 328 adjusts the output distribution of the front wheel driving unit 242 and the rear wheel driving unit 244. The operation mode of the mobile object 100 shifts from the diagnosis mode to the normal mode, and the mobile object 100 travels in the normal mode. This ends the processing.

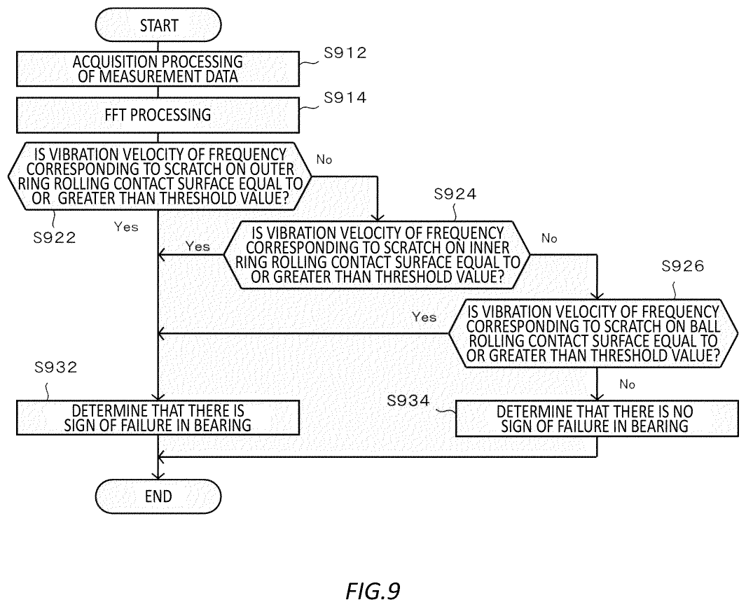

FIG. 9 schematically shows an example of information processing in the diagnosis processing execution section 348. By using FIG. 9, the information processing in the diagnosis processing execution section 348 will be described in detail by taking as an example a case where the diagnosis processing execution section 348 diagnoses a state of a bearing included in the gearbox 254 of the front wheel driving unit 242.

According to this embodiment, first, in S912, the diagnosis processing execution section 348 executes acquisition processing of measurement data. For example, the diagnosis processing execution section 348 collects output data of a predetermined sensor over a predetermined time period. For example, the diagnosis processing execution section 348 collects output data of a vibration sensor installed in the gearbox 254.

Next, in S914, the diagnosis processing execution section 348 executes fast Fourier transformation processing (which may be referred to as FFT processing) on the collected data. As a result, information indicating frequency distribution of vibration velocity, vibration intensity, amplitude or vibration acceleration, or frequency distribution of power spectrum of vibration is obtained.

Frequencies at which reaction appears in a result of the FFT processing are different depending on a position of an abnormal change that has occurred in the bearing. Therefore, performing the FFT processing on the output data of the vibration sensor can detect a sign of failure in the bearing. In this embodiment, for ease of explanation, the information processing in the diagnosis processing execution section 348 will be described in detail by taking as an example a case where the FFT processing provides the frequency distribution of the vibration velocity.

First, in S922, it is determined whether vibration velocity of a frequency corresponding to an abnormal change (for example, scratch) that has occurred on an outer ring rolling contact surface is equal to or greater than a threshold value. If the vibration velocity of the frequency corresponding to the abnormal change that has occurred on the outer ring rolling contact surface is equal to or greater than the threshold value (in case of Yes in S922), in S932, the diagnosis processing execution section 348 determines that there is the sign of failure in the bearing.

On the other hand, if the vibration velocity of the frequency corresponding to the abnormal change that has occurred on the outer ring rolling contact surface is smaller than the threshold value (in case of No in S922), in S924, it is determined whether vibration velocity of a frequency corresponding to an abnormal change (for example, scratch) that has occurred on an inner ring rolling contact surface is equal to or greater than a threshold value. If the vibration velocity of the frequency corresponding to the abnormal change that has occurred on the inner ring rolling contact surface is equal to or greater than the threshold value (in case of Yes in S924), in S932, the diagnosis processing execution section 348 determines that there is the sign of failure in the bearing.

On the other hand, if the vibration velocity of the frequency corresponding to the abnormal change that has occurred on the inner ring rolling contact surface is smaller than the threshold value (in case of No in S924), in S926, it is determined whether vibration velocity of a frequency corresponding to an abnormal change (for example, scratch) that has occurred on a ball rolling contact surface is equal to or greater than a threshold value. If the vibration velocity of the frequency corresponding to the abnormal change that has occurred on the ball rolling contact surface is equal to or greater than the threshold value (in case of Yes in S926), in S932, the diagnosis processing execution section 348 determines that there is the sign of failure in the bearing.

On the other hand, if the vibration velocity of the frequency corresponding to the abnormal change that has occurred on the ball rolling contact surface is smaller than the threshold value (in case of No in S926), in S934, the diagnosis processing execution section 348 determines that there is no sign of failure in the bearing. This ends the processing.

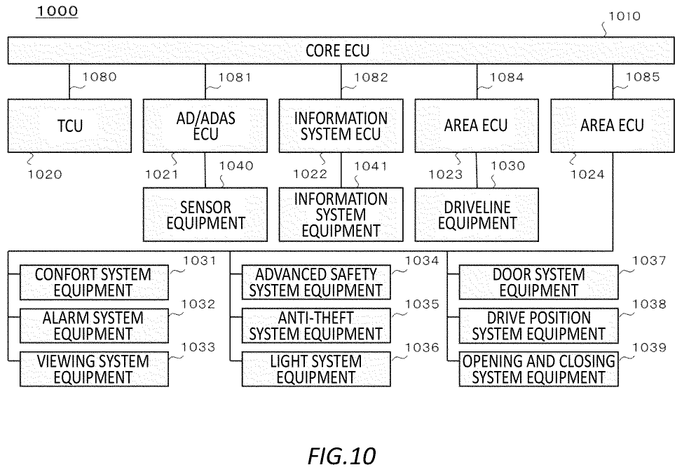

FIG. 10 schematically shows an example of an internal configuration of a vehicle 1000 which is an example of the mobile object 100. In this embodiment, the vehicle 1000 includes a core ECU 1010. In this embodiment, the vehicle 1000 includes a TCU 1020, an AD/ADAS ECU 1021, an information system ECU 1022, an area ECU 1023, and an area ECU 1024.

In this embodiment, the vehicle 1000 includes driveline equipment 1030, comfort system equipment 1031, alarm system equipment 1032, viewing system equipment 1033, advanced safety system equipment 1034, anti-theft system equipment 1035, light system equipment 1036, door system equipment 1037, drive position system equipment 1038, opening and closing system equipment 1039, sensor equipment 1040, and information system equipment 1041. In this embodiment, the vehicle 1000 includes a communication network 1080, a communication network 1081, a communication network 1082, a communication network 1084, and a communication network 1085.

Examples of the driveline equipment 1030 include an electrically driven parking brake (EPB), an electrically driven power steering (EPS) system, a vehicle stability assist (VSA) system, a shifter, a power drive unit (PDU), an intelligent power unit (IPU), a fuel injection (FI) apparatus, and the like. Examples of the sensor equipment 1040 include sensors including a camera, a radar, and a LIDAR, or the like.

The information system equipment 1041 includes at least one of information communication equipment, multimedia-related equipment, or user interface equipment, for example. Examples of the information system equipment 1041 include a narrowband communications system, meter equipment, a wireless charger, a USB port, a tuner, a player, a microphone, a speaker, display equipment, and the like. The display equipment may have a display and a speech recognition system. The display equipment may have an input apparatus such as a touch panel, a pointing device, a switch, instead of the speech recognition system or along with the speech recognition system.

The core ECU 1010 controls the whole vehicle 1000. The core ECU 1010 controls the whole vehicle 1000 by controlling the TCU 1020, the AD/ADAS ECU 1021, the information system ECU 1022, the area ECU 1023, and the area ECU 1024.

The TCU 1020 is a telematics control unit. The AD/ADAS ECU 1021 is an ECU that performs control related to automated drive (AD) and advanced driver assistance systems (ADAS). The AD/ADAS ECU 1021 is connected to each sensor included in the sensor equipment 1040 through a bus, controls each sensor included in the sensor equipment 1040, and acquires information detected by each sensor. The information system ECU 1022 is connected to each equipment included in the information system equipment 1041 through the bus, and controls each equipment included in the information system equipment 1041.

The area ECU 1023 is connected to each equipment included in the driveline equipment 1030 through the bus, and controls each equipment included in the driveline equipment 1030. The area ECU 1024 is connected, through the bus, to the comfort system equipment 1031, the alarm system equipment 1032, the viewing system equipment 1033, the advanced safety system equipment 1034, the anti-theft system equipment 1035, the light system equipment 1036, the door system equipment 1037, the drive position system equipment 1038, and the opening and closing system equipment 1039, and controls equipment included in the comfort system equipment 1031, the alarm system equipment 1032, the viewing system equipment 1033, the advanced safety system equipment 1034, the anti-theft system equipment 1035, the light system equipment 1036, the door system equipment 1037, the drive position system equipment 1038 and the opening and closing system equipment 1039.

The communication network 1080, the communication network 1081, the communication network 1082, the communication network 1084, and the communication network 1085 transmit information between a variety of equipment arranged inside the mobile object 100, for example. At least some of the communication network 1080, the communication network 1081, the communication network 1082, the communication network 1084, and the communication network 1085 may include a CAN.

The communication network 1080, the communication network 1081, the communication network 1082, the communication network 1084, and the communication network 1085 may include a network of Ethernet (registered trademark). The TCU 1020, the core ECU 1010, the AD/ADAS ECU 1021, the information system ECU 1022, the area ECU 1023, and the area ECU 1024 may be capable of IP communication via the communication network 1080, the communication network 1081, the communication network 1082, the communication network 1084, and the communication network 1085.

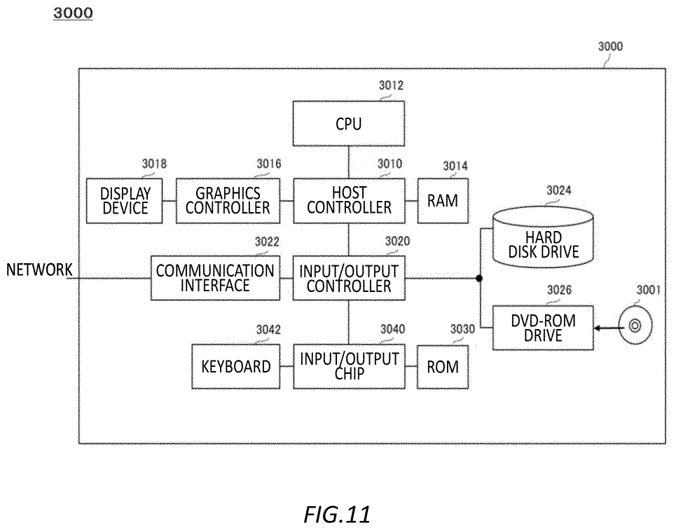

FIG. 11 shows an example of a computer 3000 in which a plurality of embodiments of the present invention may be entirely or partially embodied. For example, at least a part of the mobile object 100 is realized by the computer 3000. For example, at least a part of the control unit 160 is realized by the computer 3000. For example, at least some of the variety of ECUs described in connection to FIG. 10 are realized by the computer 3000.

A program that is installed in the computer 3000 can cause the computer 3000 to perform an operation associated with an apparatus according to the embodiment of the present invention or to function as one or more “units” of the apparatus, or cause the computer 3000 to perform the operation or the one or more units thereof, and/or cause the computer 3000 to perform processes according to the embodiment of the present invention or steps thereof. Such a program may be performed by the CPU 3012 to cause the computer 3000 to perform particular operations correlated to some or all of the blocks of flowcharts and block diagrams described herein.

The computer 3000 in accordance with this embodiment includes a CPU 3012, a RAM 3014, a graphics processing unit (GPU) 3016, and a display device 3018, which are mutually connected by a host controller 3010. The computer 3000 also includes an input/output unit such as a communication interface 3022, a hard disk drive 3024, a DVD-ROM drive 3026, and an IC card drive, which are connected to the host controller 3010 via the input/output controller 3020. The computer also includes legacy input/output units such as a ROM 3030 and a keyboard 3042, which are connected to the input/output controller 3020 via an input/output chip 3040.

The CPU 3012 operates according to programs stored in the ROM 3030 and the RAM 3014, thereby controlling each unit. The GPU 3016 acquires image data generated by the CPU 3012 on a frame buffer or the like provided in the RAM 3014 or in itself, and causes the image data to be displayed on a display device 3018.

The communication interface 3022 communicates with other electronic devices via a network. The hard disk drive 3024 stores programs and data that are used by the CPU 3012 within the computer 3000. The DVD-ROM drive 3026 reads the programs or the data from the DVD-ROM 3001, and provides the hard disk drive 3024 with the programs or the data via the RAM 3014. The IC card drive reads programs and data from an IC card and/or writes programs and data into the IC card.

The ROM 3030 stores therein a boot program or the like that is performed by the computer 3000 at the time of activation, and/or a program that is dependent on the hardware of the computer 3000. The input/output chip 3040 may also connect various input/output units to the input/output controller 3020 via a parallel port, a serial port, a keyboard port, a mouse port or the like.

A program is provided by a computer-readable storage medium, such as the DVD-ROM 3001 or the IC card. The program is read from the computer-readable storage medium, installed into the hard disk drive 3024, RAM 3014, or ROM 3030, which are also examples of computer-readable storage medium, and performed by the CPU 3012. The information processing described in these programs is read into the computer 3000, resulting in cooperation between a program and the above described various types of hardware resources. An apparatus or method may be constituted by realizing the operation or processing of information in accordance with the usage of the computer 3000.

For example, when communication is performed between the computer 3000 and an external device, the CPU 3012 may perform a communication program loaded onto the RAM 3014 to instruct communication processing to the communication interface 3022, based on the processing described in the communication program. The communication interface 3022, under the control of the CPU 3012, reads the transmission data stored in the transmission buffer region provided in the recording medium such as RAM 3014, hard disk drive 3024, DVD-ROM 3001, or IC card, and sends the read transmission data to the network or writes reception data received from the network to the reception buffer region provided on the recording medium.

In addition, the CPU 3012 may cause all or a necessary portion of a file or a database to be read into the RAM 3014, the file or the database having been stored in an external recording medium such as the hard disk drive 3024, the DVD-ROM drive 3026 (DVD-ROM 3001), the IC card, etc., and perform various types of processing on the data on the RAM 3014. The CPU 3012 may then write back the processed data to the external recording medium.

Various types of information such as various types of programs, data, tables, and databases may be stored in a recording medium and subjected to information processing. The CPU 3012 may perform various types of processing on the data read from the RAM 3014, which includes various types of operations, information processing, condition judging, conditional branch, unconditional branch, search/replacement of information, etc., as described throughout this disclosure and designated by a command sequence of programs, and writes the result back to the RAM 3014. In addition, the CPU 3012 may search for information in a file, a database, etc., in the recording medium. For example, when a plurality of entries, each having an attribute value of a first attribute correlated to an attribute value of a second attribute, are stored in the recording medium, the CPU 3012 may search for an entry whose attribute value of the first attribute matches the condition a designated condition, from among the plurality of entries, and read the attribute value of the second attribute stored in the entry, thereby acquiring the attribute value of the second attribute correlated to the first attribute meeting the predetermined condition.

The above described program or software modules may be stored in the computer-readable storage medium on or near the computer 3000. In addition, a recording medium such as a hard disk or a RAM provided in a server system connected to a dedicated communication network or the Internet can be used as the computer-readable storage medium, thereby providing the above program to the computer 3000 via the network.

While the present invention has been described above using the embodiments, a technical scope of the present invention is not limited to a scope described in the above embodiments. It is apparent to persons skilled in the art that various alterations or improvements can be made to the above-described embodiments. It is also apparent from description of the claims that the embodiments added with such alterations or improvements can also be included in the technical scope of the present invention.

The operations, procedures, steps, stages, and the like of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

20: user; 100: mobile object; 120: input/output unit; 130: thrust generation unit; 140: driving unit; 150: measurement unit; 160: control unit; 162: control section; 164: diagnosis section; 166: storage section; 220: vehicle body; 232: front wheel; 234: rear wheel; 242: front wheel driving unit; 244: rear wheel driving unit; 252: motor; 254: gearbox; 256: shaft; 262: brake; 322; input/output control section; 324: required driving force decision section; 326: diagnosis driving force decision section; 328: driving control section; 342: diagnosis manner decision section; 344: diagnosis timing decision section; 346: start determination section; 348: diagnosis processing execution section; 362: diagnosis interval storage section; 364: diagnosis driving force storage section; 1000: vehicle; 1010: core ECU; 1020: TCU; 1021: ECU; 1022: information system ECU; 1023: area ECU; 1024: area ECU; 1030: driveline equipment; 1031: comfort system equipment; 1032: alarm system equipment; 1033: viewing system equipment; 1034: advanced safety system equipment; 1035: anti-theft system equipment; 1036: light system equipment; 1037: door system equipment; 1038: drive position system equipment; 1039: opening and closing system equipment; 1040: sensor equipment; 1041: information system equipment; 1080: communication network; 1081: communication network; 1082: communication network; 1084: communication network; 1085: communication network; 3000: computer; 3001: DVD-ROM; 3010: host controller; 3012: CPU; 3014: RAM; 3016: GPU; 3018: display device; 3020: input/output controller; 3022: communication interface; 3024: hard disk drive; 3026: DVD-ROM drive; 3030: ROM; 3040: input/output chip; and 3042: keyboard.

What is claimed is:

1. A diagnosis apparatus that is mounted on equipment and is configured to diagnose a state of the equipment, comprising
a timing decision section configured to decide timing at which the diagnosis apparatus diagnoses the state of the equipment, wherein
the timing decision section is configured to decide the timing such that:
a length of a time interval for a diagnosis during a first time period is equal to or less than a first reference value; and
a length of a time interval for a diagnosis during a second time period is greater than the first reference value, and
the first time period and the second time period do not temporally overlap.

2. The diagnosis apparatus according to claim 1, further comprising
a manner decision section configured to decide a manner in which the diagnosis apparatus diagnoses the equipment, wherein
the timing decision section is configured to,
when the manner decision section decides to operate the diagnosis apparatus in a manner in which a periodical diagnosis of the equipment is performed,
decide the timing such that:
a length of a time interval for the periodical diagnosis during the first time period is equal to or less than the first reference value; and
a length of a time interval for the periodical diagnosis during the second time period is greater than the first reference value.

3. The diagnosis apparatus according to claim 1, wherein
the timing decision section is configured to,
when a length of an elapsed time period from a first time point which is a time point where the equipment is produced or transferred to a utilizer of the equipment is smaller than a predetermined first threshold value,
decide the timing based on a length of a first time interval which is the time interval during the first time period.

4. The diagnosis apparatus according to claim 2, wherein
the timing decision section is configured to,
when a length of an elapsed time period from a first time point which is a time point where the equipment is produced or transferred to a utilizer of the equipment is smaller than a predetermined first threshold value,
decide the timing based on a length of a first time interval which is the time interval during the first time period.

5. The diagnosis apparatus according to claim 3, wherein
the timing decision section is configured to (i) decide, as the length of the first time interval, a predetermined value or a value designated by a user or (ii) decide the length of the first time interval based on the length of the elapsed time period from the first time point.

6. The diagnosis apparatus according to claim 3, wherein
the first time period is a time period from the first time point, to a second time point where the length of the elapsed time period from the first time point is the first threshold value, and
the second time period is a time period after the second time point is exceeded, until a third time point where a degree of a load inputted to the equipment during the elapsed time period from the first time point reaches a predetermined degree.

7. The diagnosis apparatus according to claim 3, wherein
the timing decision section is configured to,
when the length of the elapsed time period from the first time point is greater than the first threshold value and a degree of a load inputted to the equipment during the elapsed time period from the first time point is smaller than a predetermined first degree,
decide the timing based on a length of a second time interval which is the time interval during the second time period.

8. The diagnosis apparatus according to claim 5, wherein
the timing decision section is configured to,
when the length of the elapsed time period from the first time point is greater than the first threshold value and a degree of a load inputted to the equipment during the elapsed time period from the first time point is smaller than a predetermined first degree,
decide the timing based on a length of a second time interval which is the time interval during the second time period.

9. The diagnosis apparatus according to claim 1, wherein
the timing decision section is configured to,
when a degree of a load inputted to the equipment during an elapsed time period from a first time point which is a time point where the equipment is produced or transferred to a utilizer of the equipment is smaller than a predetermined first degree,
decide the timing based on a length of a second time interval which is the time interval during the second time period.

10. The diagnosis apparatus according to claim 2, wherein
the timing decision section is configured to,
when a degree of a load inputted to the equipment during an elapsed time period from a first time point which is a time point where the equipment is produced or transferred to a utilizer of the equipment is smaller than a predetermined first degree,
decide the timing based on a length of a second time interval which is the time interval during the second time period.

11. The diagnosis apparatus according to claim 7, wherein
the timing decision section is configured to (i) decide, as the length of the second time interval, a predetermined value or a value designated by a user or (ii) decide the length of the second time interval based on the degree of the load inputted to the equipment during the elapsed time period from the first time point.

12. The diagnosis apparatus according to claim 9, wherein
the timing decision section is configured to (i) decide, as the length of the second time interval, a predetermined value or a value designated by a user or (ii) decide the length of the second time interval based on the degree of the load inputted to the equipment during the elapsed time period from the first time point.

13. The diagnosis apparatus according to claim 1, wherein
the timing decision section is configured to decide the timing such that:
a length of a time interval for a diagnosis during a third time period is equal to or less than a second reference value; and
the length of the time interval for the diagnosis during the second time period is greater than the second reference value, and
the first time period, the second time period, and the third time period do not temporally overlap.

14. The diagnosis apparatus according to claim 13, wherein
the second time period starts after the first time period ends, and
the third time period starts after the second time period ends.

15. The diagnosis apparatus according to claim 14, wherein
the first reference value and the second reference value are equal, or
an absolute value of difference between the first reference value and the second reference value is less than 24 hours.

16. The diagnosis apparatus according to claim 3, wherein
the timing decision section is configured to,
when the length of the elapsed time period from the first time point is greater than the first threshold value and smaller than a predetermined second threshold value,
decide the timing based on a length of a second time interval which is the time interval during the second time period.

17. The diagnosis apparatus according to claim 9, wherein
the timing decision section is configured to,
when the degree of the load inputted to the equipment during the elapsed time period from the first time point is (a) greater than the first degree or (b) smaller than a predetermined second degree,
decide the timing based on a length of a first time interval which is the time interval during the first time period, and
the second degree indicates to be smaller than the first degree in terms of the degree of the load.

18. Equipment comprising the diagnosis apparatus according to claim 1.

19. A non-transitory computer-readable storage medium having stored thereon a program that causes a computer to function as a diagnosis apparatus that is mounted on equipment and is configured to diagnose a state of the equipment, wherein
the diagnosis apparatus includes
a timing decision section configured to decide timing at which the diagnosis apparatus diagnoses the state of the equipment,
the timing decision section is configured to decide the timing such that:
a length of a time interval for a diagnosis during a first time period is equal to or less than a first reference value; and
a length of a time interval for a diagnosis during a second time period is greater than the first reference value, and
the first time period and the second time period do not temporally overlap.

20. A control method of a diagnosis apparatus that is mounted on equipment and is configured to diagnose a state of the equipment, comprising
deciding timing at which the diagnosis apparatus diagnoses the state of the equipment, wherein
the deciding timing includes
deciding the timing such that a length of a time interval for a diagnosis during a first time period is equal to or less than a first reference value, and a length of a time interval for a diagnosis during a second time period is greater than the first reference value, and
the first time period and the second time period do not temporally overlap.
